(19) United States
(12) Patent Application Publication
(10) Pub. No.: US 2019/0283085 A1
(43) Pub. Date: Sep. 19, 2019

(54) AUTO BRUSHING DEVICE FOR BENDERS

(71) Applicant: Seoul Laser Dieboard System Co., Ltd., Lake Forest, CA (US)

(72) Inventor: Kyong Chan LIM, San Diego, CA (US)

(21) Appl. No.: 16/356,981

(22) Filed: Mar. 18, 2019

Related U.S. Application Data
(60) Provisional application No. 62/644,227, filed on Mar. 16, 2018.

(51) Int. Cl. B08B 1/00; B08B 1/02; A46B 13/00; A46B 13/02; A46B 15/00

(52) U.S. Cl. CPC B08B 1/002; B08B 1/02; A46B 15/0055; A46B 13/02; A46B 13/001

(57) ABSTRACT

An auto brushing device for brushing a rule, including: at least one brushing roller configured to rotate to brush against the rule to remove various impurities; a first unit configured to control rotational speeds of the at least one brushing roller; and a second unit configured to control distances of the at least one brushing roller from the rule.

### CROSS-REFERENCE TO RELATED APPLICATIONS

This application claims the benefit of priority under 35 U.S.C. § 119(e) of co-pending U.S. Provisional Patent Application No. 62/644,227, filed Mar. 16, 2018, entitled “Auto Brushing Device for Benders.” The disclosure of the above-referenced application is incorporated herein by reference.

### BACKGROUND

Three-dimensional signage displays are installed to inform the consumers of the name and nature of the businesses. Thus, the signage displays enable the consumers to easily recognize and understand the nature of the businesses. The signage displays include illumination units to easily identify the businesses during the day as well as night time.

A three-dimensional signage display 100 is described with reference to FIG. 1. The three-dimensional signage display 100 includes a side frame 120 with a tubular opening (sometimes referred to as “letter box”), an upper panel and cover 110 (which rests on top of the side frame 120), and a base module 130 which includes illumination devices 132 such as light emitting diodes (LEDs).

The side frame 120 can be formed with a strip of metallic material such as aluminum or steel. Thus, a bender bends the strip of metallic material (sometimes referred to a rule or profile) into the three-dimensional shape such that the light from the illumination devices is transmitted through the upper panel 110 to light the three-dimensional signage 100. The bending process may also include flanging (i.e., folding of one side of the side frame 120) to form a flange 122 and notching 124 (i.e., V-cutting or V-stamping) where the side frame 120 is to be bent.

### SUMMARY

The present disclosure includes an auto brushing device for brushing a rule. The auto brushing device includes: at least one brushing roller configured to rotate to brush against the rule to remove various impurities; a first unit configured to control rotational speeds of the at least one brushing roller; and a second unit configured to control distances of the at least one brushing roller from the rule.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a three-dimensional signage display;

FIG. 2 shows the auto brushing device receiving the rule from a roll;

FIG. 3 shows another perspective view of the auto brushing device in accordance with one implementation;

FIG. 4 shows a rear perspective view of the auto brushing device in accordance with one implementation;

FIG. 5 shows a front perspective view of the auto brushing device in accordance with one implementation; and

FIG. 6 shows a top view of the auto brushing device including the inside view (shown in dotted lines) in accordance with one implementation.

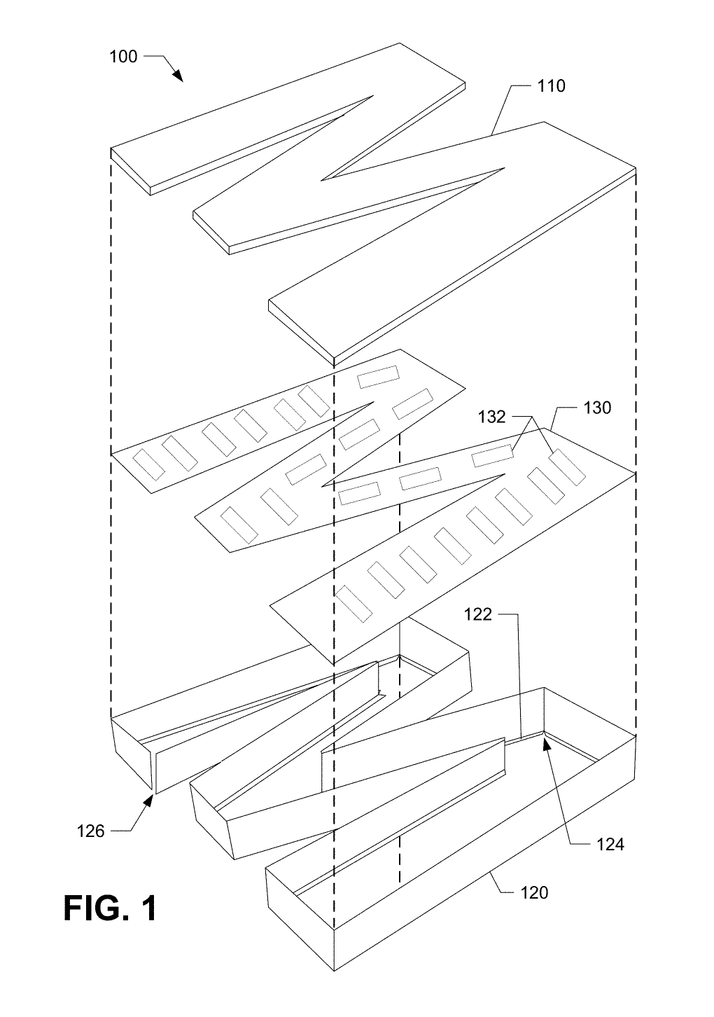

### DETAILED DESCRIPTION

Prior to bending the rule to form the letter box, the rule needs to be processed. For example, the rule should be processed to remove any dust or stain as well as oil on the surface. In one implementation, the auto brushing device of the present disclosure performs the above-described pre-processing.

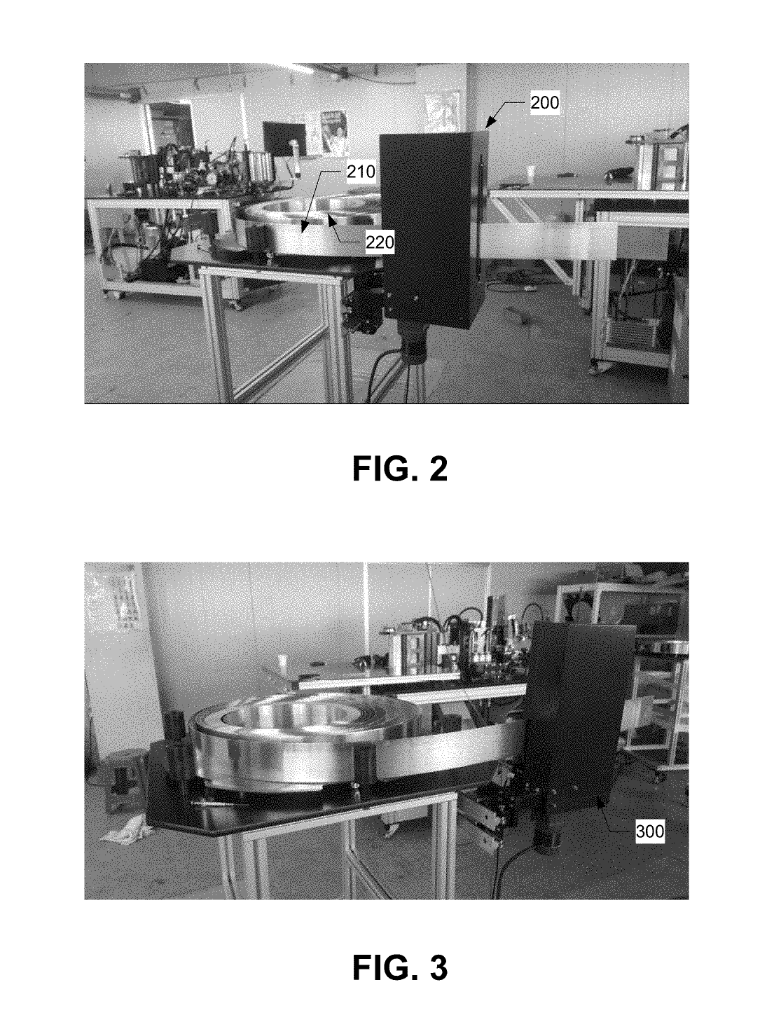

FIGS. 2-5 show different views of the auto brushing device.

For example, FIG. 2 shows the auto brushing device 200 receiving the rule 210 from a roll 220. The rule 210 passes through the auto brushing device 200 to remove various impurities, oil and dust from the raw materials including the rule 210. After the impurities removal process, the rule is then fed into a bender for the channel bending process to form a channel letter.

In one implementation, the auto brushing device 200 can be configured as a stand-alone device. In another implementation, the auto brushing device 200 can be configured as a part of the bender such as a channel bender.

FIG. 3 shows another perspective view of the auto brushing device 300 in accordance with one implementation.

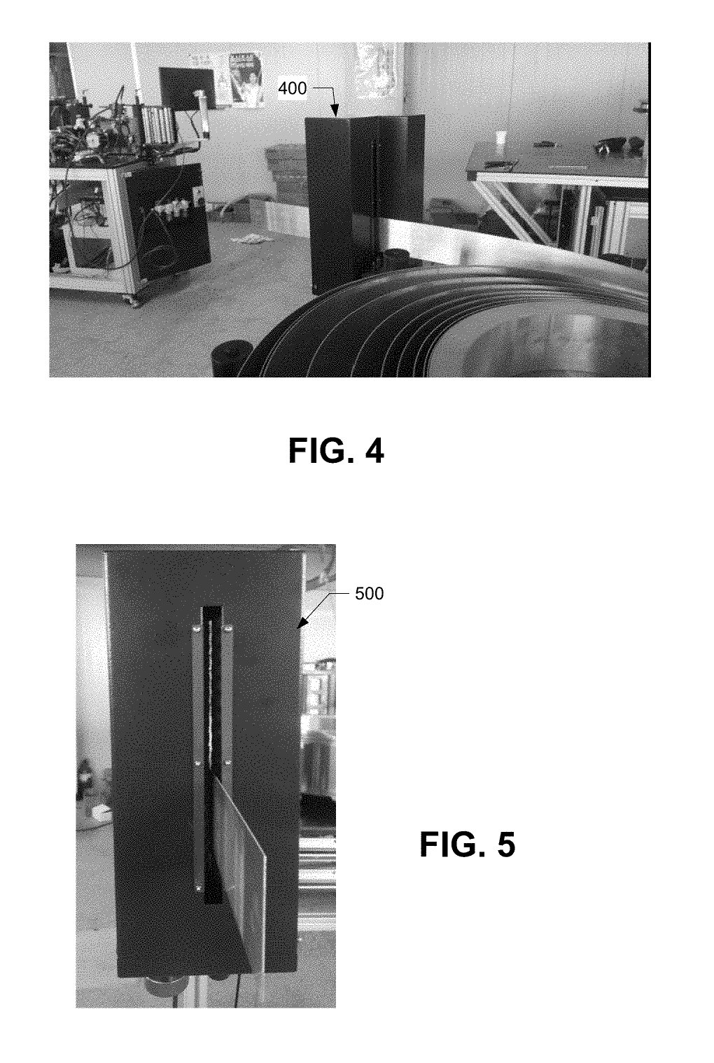

FIG. 4 shows a rear perspective view of the auto brushing device 400 in accordance with one implementation.

FIG. 5 shows a front perspective view of the auto brushing device 500 in accordance with one implementation.

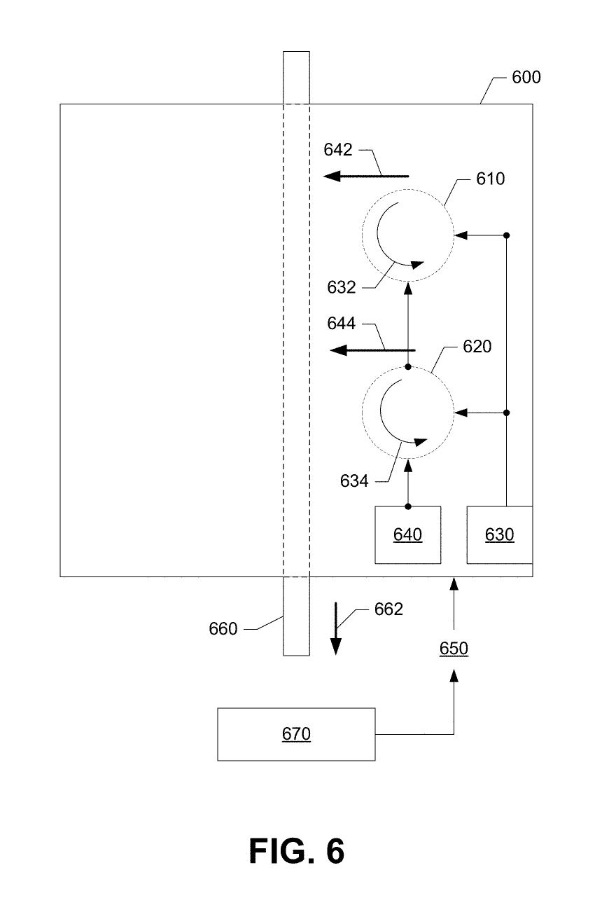

FIG. 6 shows a top view of the auto brushing device 600 including the inside view (shown in dotted lines) in accordance with one implementation. In FIG. 6, the rule 660 is fed into the auto brushing device 600 in the direction 662 as shown. In one implementation, the rule 660 can be fed into a bender 670 for bending to form a channel letter.

Within the auto brushing device 600 shown in FIG. 6, at least one brush roller 610, 620 is rotated 612, 622 for the above-described pre-processing including removing various impurities, oil and dust from the rule 660.

In one implementation, the auto brushing device 600 includes a rotation control unit 630 capable of adjusting the rotational speed 632, 634 of the brushing rollers 610, 620. The speed 632 corresponds to the rotational speed of the brushing roller 610, while the speed 634 corresponds to the rotational speed of the brushing roller 620.

In one implementation, the speed may be adjusted in accordance with the speed at which the rule 660 is moving through the bender. Thus, in one implementation, the feedback input 650 comes from the bender. Therefore, by adjusting the speed of the brushing rollers 610, 620, the streaks on the rule 660 can be prevented when the bender 670 slows down and the rule 660 get bogged down in the auto brushing device 600. However, in some cases, slowing the brushing rollers 610, 620 down to almost stop position and starting them up again causes blotches or marks on the rule 660.

Accordingly, in one implementation, the auto brushing device 600 includes a unit 640 capable of adjusting the distance 642, 644 between material 660 and the brushing rollers 610, 620. The distance 642 corresponds to the distance between the rule 660 and the brushing roller 610, while the distance 644 corresponds to the distance between the rule 660 and the brushing roller 620. In one implementation, the distance may be adjusted in accordance with the thickness of the material (e.g., the rule).

In one implementation, the brushing rollers 610, 620 are only actuated when the rule 660 is being moved through the auto brushing device 600. This prevents the material from being sanded too much. This also prevents blotches or marks on the rule 660 when the brushing rollers 610, 620 start up from almost stop position. Thus, in this implementation, the brushing rollers 610, 620 are not actuated (or touching the rule 660) when there is no rule being moved through the auto brushing device 600 or the rule 660 is not moving through the device 600 but is resting.

In another implementation, the brushing rollers 610, 620 are actuated even when the material is being moved through the auto brushing device at a very slow speed or not at all. This implementation may work well with a very thick material.

The above descriptions of the disclosed embodiments are provided to enable any person skilled in the art to make or use the invention. Various modifications to these embodiments will be readily apparent to those skilled in the art, and the generic principles described herein can be applied to other embodiments without departing from the spirit or scope of the invention. Thus, it will be understood that the description and drawings presented herein represent embodiments of the invention and are therefore representative of the subject matter which is broadly contemplated by the present invention. It will be further understood that the scope of the present invention fully encompasses other embodiments that may become obvious to those skilled in the art and that the scope of the present invention is accordingly limited by nothing other than the appended claims.

Accordingly, the foregoing embodiments are merely presented as examples and are not to be construed as limiting the present invention. The present teachings can be readily applied to other types of apparatus and/or devices. The description of the present invention is intended to be illustrative, and not to limit the scope of the claims. Many alternatives, modifications, and variations will be apparent to those skilled in the art.

What is claimed is:

1. An auto brushing device for brushing a rule, the auto brushing device comprising:
at least one brushing roller configured to rotate to brush against the rule to remove various impurities;
a first unit configured to control rotational speeds of the at least one brushing roller; and
a second unit configured to control distances of the at least one brushing roller from the rule.
